(19) United States
(12) Patent Application Publication
(10) Pub. No.: US 2025/0286175 A1
(43) Pub. Date: Sep. 11, 2025

(54) SECONDARY BATTERY, AND DEVICE AND METHOD FOR MANUFACTURING SECONDARY BATTERY

(71) Applicant: Samsung SDI Co., Ltd., Yongin-si (KR)

(72) Inventor: Jin Seon Shin, Suwon-si (KR)

(21) Appl. No.: 18/913,095

(22) Filed: Oct. 11, 2024

(30) Foreign Application Priority Data
Mar. 5, 2024 (KR) 10-2024-0031548

(51) Int. Cl. H01M 50/124; H01M 10/04

(52) U.S. Cl. CPC H01M 50/1243; H01M 10/0409; H01M 10/0431

(57) ABSTRACT

The present disclosure relates to a secondary battery, and a device and method for manufacturing the secondary battery and is directed to providing a secondary battery in which rigidity can be increased and an insulation property can be secured, and a device and method for manufacturing the secondary battery. To this end, the present disclosure provides a secondary battery including an electrode assembly, and a housing provided with an accommodating part in which the electrode assembly is accommodated and an insulating part protruding from the accommodating part toward the electrode assembly.

### CROSS-REFERENCE TO RELATED APPLICATIONS

This present application claims priority to and the benefit under 35 U.S.C. § 119(a)-(d) of Korean Patent Application No. 10-2024-0031548, filed on Mar. 5, 2024, in the Korean Intellectual Property Office, the entire disclosure of which is incorporated herein by reference.

### FIELD

The present disclosure relates to a secondary battery, and a device and method for manufacturing the secondary battery.

### BACKGROUND

In general, with rapidly increasing demand for portable electronics, such as laptops, video cameras, and mobile phones, and commercialization of robots and electric vehicles, research is actively carried out to develop high-performance secondary batteries enabling repeated charging/discharging.

Secondary batteries are widely used in small devices, such as portable electronics, as well as medium and large devices, such as electric vehicles and energy storage systems (ESS), for power generation and energy storage. In particular, in medium or large devices, multiple battery cells are electrically connected to each other to form a battery module in order to enhance output and/or capacity of the batteries.

The above information disclosed in this Background section is provided for enhancement of understanding of the background of the present disclosure, and, therefore, it may contain information that does not constitute related (or prior) art.

### SUMMARY

The present invention is directed to providing a secondary battery in which rigidity can be increased and an insulation property can be secured, and a device and method for manufacturing the secondary battery.

These and other aspects and features of the present disclosure will be described in or will be apparent from the following description of some embodiments of the present disclosure.

A secondary battery according to one embodiment of the present invention includes an electrode assembly, and a housing provided with an accommodating part in which the electrode assembly is accommodated and an insulating part protruding from the accommodating part toward the electrode assembly.

The housing may include a container provided with the accommodating part and a cover coupled to the container to cover an opening provided in one surface of the container.

The housing may include a first container that covers a first portion of the electrode assembly and a second container coupled to the first container to cover a second portion of the electrode assembly.

The accommodating part may include a first accommodating part provided in the first container to accommodate the first portion and a second accommodating part provided in the second container to accommodate the second portion.

The insulating part may include a plurality of protrusions disposed to be spaced apart from each other.

The plurality of protrusions may be formed in any one of a circular shape, an elliptical shape, a polygonal shape, a cross shape, a zigzag shape, and a wavy shape.

A device for manufacturing a secondary battery according to one embodiment of the present invention includes a die on which a metal sheet is seated and which is provided with a recess having a shape corresponding to an accommodating part in which an electrode assembly is accommodated, a punch disposed to be movable toward the die and provided with a punch head inserted into the recess while pressing the metal sheet to mold the accommodating part in the metal sheet, and a molding part provided on the punch head and molding an insulating part protruding toward the electrode assembly in the accommodating part.

The device may further include a stripper seated on the metal sheet to fix the metal sheet to the die.

A through hole through which the punch head passes may be provided in the stripper.

The recess may include a first recess and a second recess disposed to be spaced apart from the first recess.

The punch head may include a first punch head inserted into the first recess and a second punch head disposed to be spaced apart from the first punch head and inserted into the second recess.

The molding part may include a plurality of patterns disposed to be spaced apart from each other and engraved in the punch head.

The molding part may include a molding body portion detachably coupled to the punch head and a plurality of patterns engraved in the molding body portion and disposed to be spaced apart from each other.

The plurality of patterns may be formed on an outer surface of the molding body portion in a direction in which the metal sheet seated on the die is located.

The plurality of patterns may be formed in any one of a circular shape, an elliptical shape, a polygonal shape, a cross shape, a zigzag shape, and a wavy shape.

A method of manufacturing a secondary battery according to one embodiment of the present invention includes molding an insulating part, which protrudes from a first accommodating part toward an electrode assembly while molding the first accommodating part in which the electrode assembly is accommodated, in a first portion of a metal sheet, slitting both sides of a second portion in a first direction so that the second portion of the metal sheet is limited to a set area, bending the second portion toward the first portion so that the second portion overlaps the first portion, folding an area between the first portion and the second portion, and cutting one side of the first portion and one side of the second portion in a second direction intersecting the first direction.

The method may further include molding the insulating part, which protrudes from a second accommodating part toward the electrode assembly while molding the second accommodating part in which the electrode assembly is accommodated, in the second portion.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure should not be construed as being limited to the drawings:

FIG. 1 is a perspective view schematically showing a secondary battery according to a first embodiment of the present invention.

FIG. 2 is a perspective view schematically showing a secondary battery according to a second embodiment of the present invention.

FIGS. 3 to 6 are plan views schematically showing an insulating part according to the embodiment of the present invention.

FIG. 7 is an exploded perspective view schematically showing a device for manufacturing the secondary battery according to the first embodiment of the present invention.

FIG. 8 is a bottom perspective view schematically showing a punch in the device for manufacturing the secondary battery according to the first embodiment of the present invention.

FIG. 9 is an exploded perspective view schematically showing a device for manufacturing the secondary battery according to the second embodiment of the present invention.

FIG. 10 is a bottom perspective view schematically showing a punch in the device for manufacturing the secondary battery according to the second embodiment of the present invention.

FIGS. 11 to 14 are perspective views schematically showing an insulation molding part according to the embodiment of the present invention.

FIG. 15 is a flowchart schematically showing a method of manufacturing the secondary battery according to the first embodiment of the present invention.

FIG. 16 is a flowchart schematically showing a method of manufacturing the secondary battery according to the second embodiment of the present invention.

### DETAILED DESCRIPTION

Herein, some embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

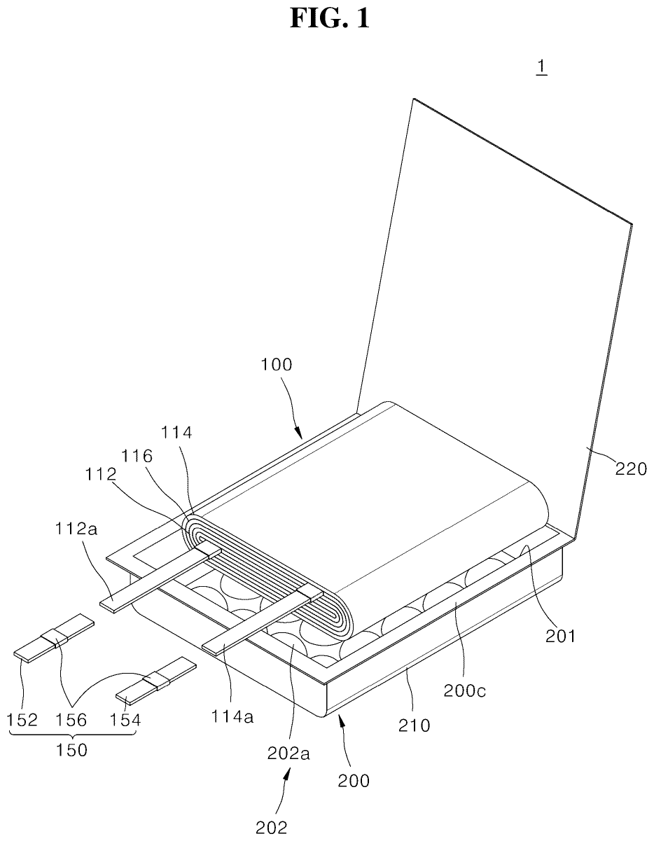

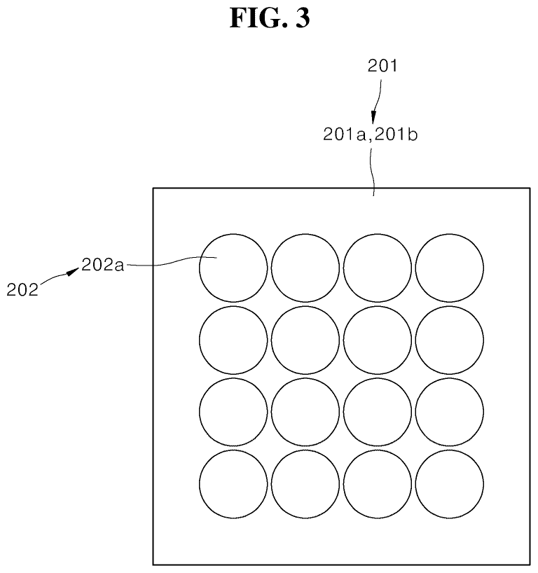

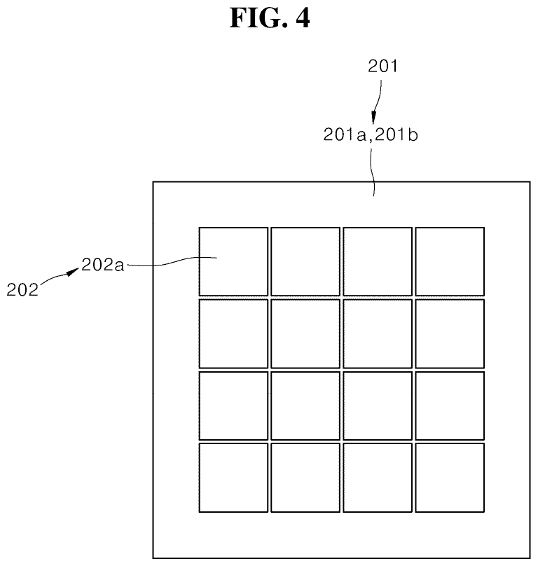

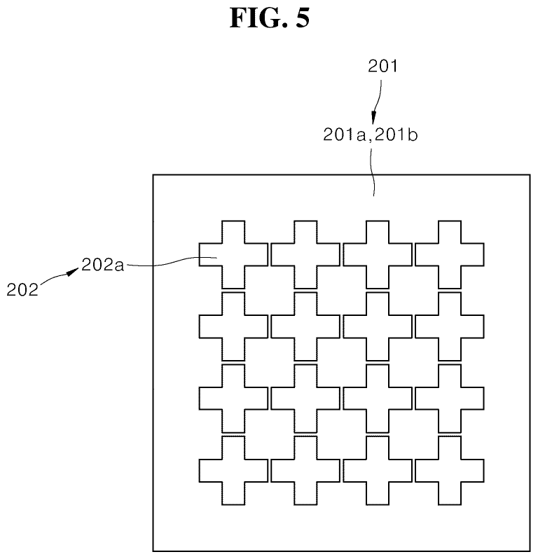

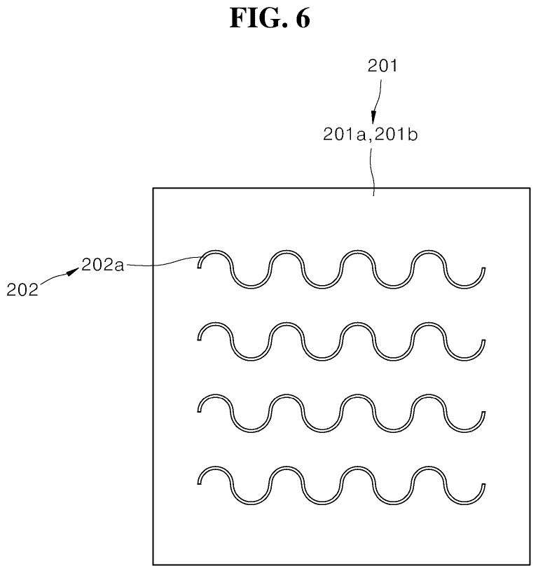

FIG. 1 is a perspective view schematically showing a secondary battery according to a first embodiment of the present invention, and FIGS. 3 to 6 are plan views schematically showing an insulating part according to an embodiment of the present invention.

Referring to FIGS. 1 and 3 to 6, a secondary battery 1 according to embodiments of the present invention includes an electrode assembly 100 and a housing 200.

The electrode assembly 100 includes a negative electrode plate 112 as a first electrode plate, a positive electrode plate 114 as a second electrode plate, and a separator 116 interposed therebetween. The negative electrode plate 112 is provided with a negative electrode tab 112a electrically connected to a negative electrode uncoated portion, and the positive electrode plate 114 is provided with a positive electrode tab 114a electrically connected to a positive electrode uncoated portion. The negative electrode tab 112a and the positive electrode tab 114a are electrically connected to an external device by being welded to a negative electrode lead 152 and a positive electrode lead 154 of an external terminal. A tab film 156 for insulation from the housing 200 is attached to the negative electrode lead 152 and the positive electrode lead 154.

The housing 200 accommodates the electrode assembly 100. The housing 200 is provided with an accommodating part 201 in which the electrode assembly 100 is accommodated and an insulating part 202 protruding from the accommodating part 201 toward the electrode assembly 100.

The housing 200 is sealed by bringing sealing parts 200c formed at an edge thereof into contact with each other in a state of accommodating the electrode assembly 100. In this case, the sealing is performed with the tab film 156 disposed between the sealing parts 200c.

The sealing part 200c of the housing 200 is made of a heat-sealable material and has a structure in which sealing is achieved by bonding heat-sealable layers to each other. Since heat-sealable materials generally have weak adhesion to metal, a thin film-shaped tab film 156 may be attached to the tab and fused to the housing 200.

The housing 200 may include a container 210 and a cover 220. The container 210 may be provided with the accommodating part 201 in which the electrode assembly 100 is accommodated. The insulating part 202 may be provided in the accommodating part 201. The insulating part 202 may be formed to protrude from an inner surface of the accommodating part 201. The electrode assembly 100 may be seated on the insulating part 202.

An insulating layer may be formed between the container 210 and the electrode assembly 100 by the insulating part 202 formed in the accommodating part 201. Therefore, the characteristics of the electrode assembly 100 are not significantly changed even when an external temperature changes, and it is possible to prevent damage to the electrode assembly 100 even when an external force is applied to the container 210.

The insulating part 202 may include a protrusion 202a. A plurality of protrusions 202a may be disposed to be spaced apart from each other on the inner surface of the accommodating part 201. The protrusion 202a may be formed in any one of a circular shape, an elliptical shape, a polygonal shape, a cross shape, a zigzag shape, and a wavy shape.

One surface of the container 210 may be provided with an opening through which the electrode assembly 100 may enter and exit. The cover 220 may be coupled to the container 210 to cover the opening of the container 210. The cover 220 may be provided integrally with the container 210. One side of the container 210 may be connected to one side of the cover 220. The cover 220 may be rotatably connected to the container 210 via a hinge part.

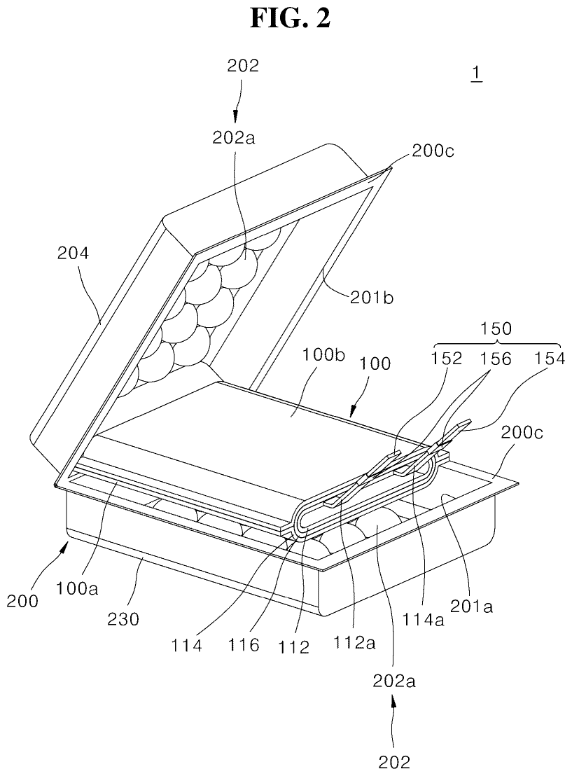

FIG. 2 is a perspective view schematically showing a secondary battery according to a second embodiment of the present invention. Referring to FIGS. 2 and 3 to 6, a secondary battery 1 according to the second embodiment of the present invention includes an electrode assembly 100 and a housing 200.

The electrode assembly 100 includes a negative electrode plate 112 as a first electrode plate, a positive electrode plate 114 as a second electrode plate, and a separator 116 interposed therebetween. The negative electrode plate 112 is provided with a negative electrode tab 112a electrically connected to a negative electrode uncoated portion, and the positive electrode plate 114 is provided with a positive electrode tab 114a electrically connected to a positive electrode uncoated portion. The negative electrode tab 112a and the positive electrode tab 114a are electrically connected to an external device by being welded to a negative electrode lead 152 and a positive electrode lead 154 of an external terminal. A tab film 156 for insulation from the housing 200 is attached to the negative electrode lead 152 and the positive electrode lead 154.

The housing 200 accommodates the electrode assembly 100. The housing 200 is provided with an accommodating part 201 in which the electrode assembly 100 is accommodated and an insulating part 202 protruding from the accommodating part 201 toward the electrode assembly 100.

The housing 200 is sealed by bringing sealing parts 200c formed at an edge thereof into contact with each other in a state of accommodating the electrode assembly 100. In this case, the sealing is performed with the tab film 156 disposed between the sealing parts 200c.

The sealing parts 200c of the housing 200 are made of a heat-sealable material and has a structure in which sealing is achieved by bonding heat-sealable layers to each other. Since heat-sealable materials generally have weak adhesion to metal, a thin film-shaped tab film 156 is attached to the tab and fused to the housing 200.

The housing 200 may include a first container 230 and a second container 240. The first container 230 may cover a first portion 100a of the electrode assembly 100. The first container 230 may be provided with a first accommodating part 201a. The first portion 100a of the electrode assembly 100 may be accommodated in the first accommodating part 201a of the first container 230.

The insulating part 202 may be provided in the first accommodating part 201a. The insulating part 202 is formed to protrude from an inner surface of the first accommodating part 201a. The first portion 100a of the electrode assembly 100 may be seated on the insulating part 202.

An insulating layer may be formed between the first container 230 and the electrode assembly 100 by the insulating part 202 formed in the first accommodating part 201a. Therefore, the characteristics of the electrode assembly 100 are not significantly changed even when an external temperature changes, and it is possible to prevent damage to the electrode assembly 100 even when an external force is applied to the first container 230.

The insulating part 202 may include a protrusion 202a. A plurality of protrusions 202a may be disposed to be spaced apart from each other on the inner surface of the first accommodating part 201a. The protrusion 202a may be formed in any one of a circular shape, an elliptical shape, a polygonal shape, a cross shape, a zigzag shape, and a wavy shape.

The second container 240 may be coupled to the first container 230. The second container 240 may be provided integrally with the first container 230. One side of the first container 230 may be connected to one side of the second container 240. The second container 240 may be rotatably connected to the first container 230 via a hinge part.

The second container 240 may cover a second portion 100b of the electrode assembly 100. The second container 240 may be provided with a second accommodating part 201b. The second portion 100b of the electrode assembly 100 may be accommodated in the second accommodating part 201b of the second container 240.

The insulating part 202 may be provided in the second accommodating part 201b. The insulating part 202 is formed to protrude from an inner surface of the second accommodating part 201b. The second portion 100b of the electrode assembly 100 may be seated on the insulating part 202.

An insulating layer may be formed between the second container 240 and the electrode assembly 100 by the insulating part 202 formed in the second accommodating part 201b. Therefore, the characteristics of the electrode assembly 100 are not significantly changed even when an external temperature changes, and it is possible to prevent damage to the electrode assembly 100 even when an external force is applied to the second container 240.

The insulating part 202 may include protrusions 202a. A plurality of protrusions 202a may be disposed to be spaced apart from each other on the inner surface of the second accommodating part 201b. Each of protrusions 202a may be formed in any one of a circular shape, an elliptical shape, a polygonal shape, a cross shape, a zigzag shape, and a wavy shape.

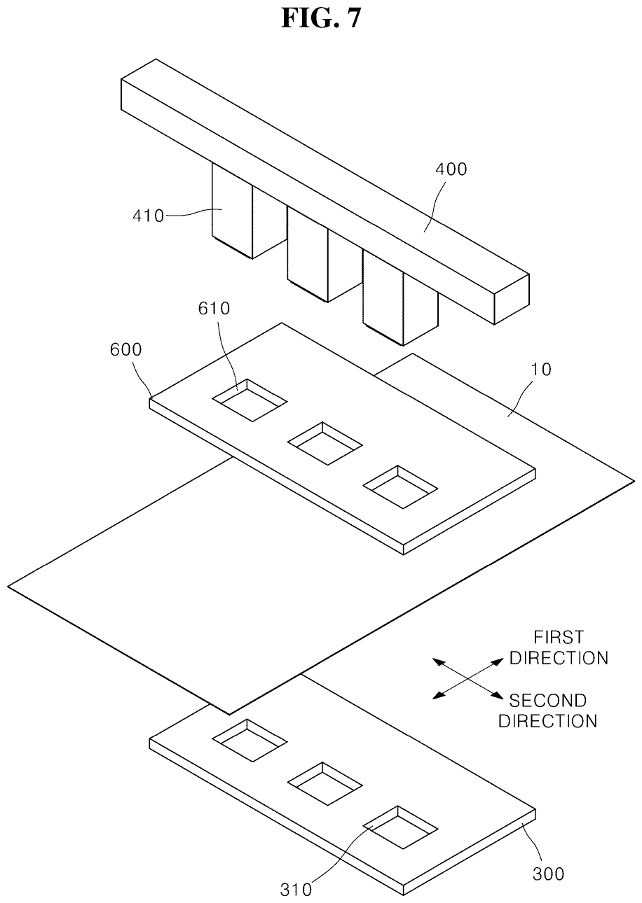

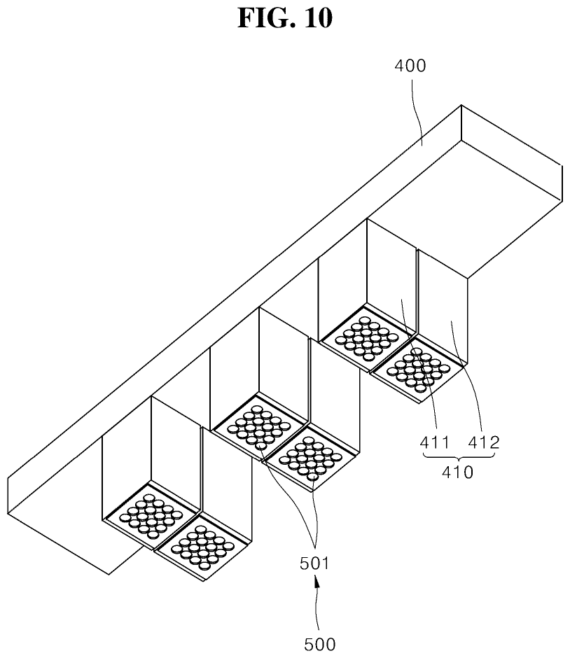

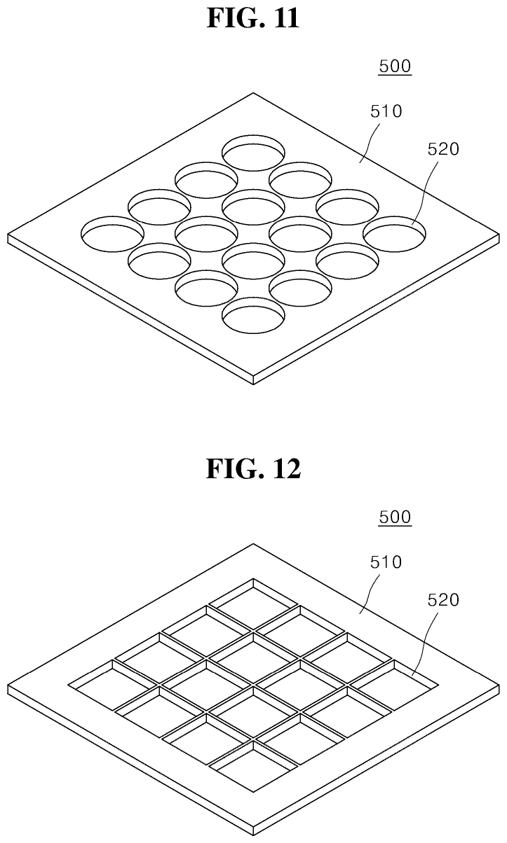

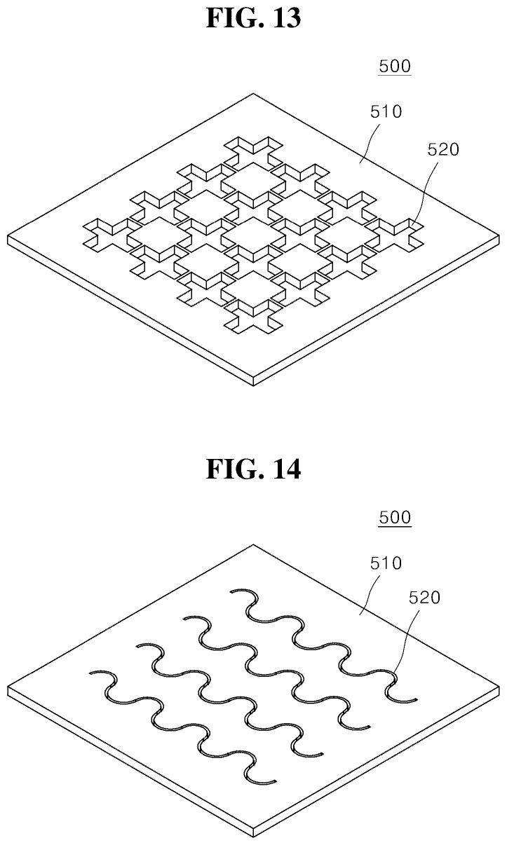

FIG. 7 is an exploded perspective view schematically showing a device for manufacturing the secondary battery according to the first embodiment of the present invention, FIG. 8 is a bottom perspective view schematically showing a punch in the device for manufacturing the secondary battery according to the first embodiment of the present invention, and FIGS. 11 to 14 are perspective views schematically showing an insulation molding part according to the embodiment of the present invention.

Referring to FIGS. 1, 7, 8, and 11 to 14, the device for manufacturing the secondary battery according to the first embodiment of the present invention may include a die 300, a punch 400, a molding part 500, and a stripper 600.

A metal sheet 10 may be seated on the die 300. The metal sheet 10 may be a material for the housing 200 that accommodates the electrode assembly 100 in the secondary battery 1 according to the first embodiment of the present invention.

The die 300 may be provided with a recess 310 for molding the accommodating part 201 that is formed in the housing 200 to accommodate the electrode assembly 100. The recess 310 may be formed to be recessed in an outer surface of the die 300 on which the metal sheet 10 is seated.

The recess 310 may be formed to have a shape corresponding to the accommodating part 201 in which the electrode assembly 100 is accommodated. In other words, the recess 310 may be formed in a size corresponding to the accommodating part 201. The recess 310 may be formed by recessing the die 300 to a set depth and formed to pass through the die 300 in the thickness direction.

The punch 400 may be spaced apart from and disposed to face the die 300 and to be movable toward the die 300. The die 300 may move back and forth. The punch 400 may be provided with a punch head 410. The punch head 410 may protrude from the punch 400 and extend in the direction in which the die 300 is located.

The punch head 410 may be inserted into the recess 310 while pressing the metal sheet 10 seated on the die 300 to mold the accommodating part 201 in the metal sheet 10.

The molding part 500 may be provided on the punch head 410. The molding part 500 may mold the insulating part 202 which protrudes toward the electrode assembly 100 in the accommodating part 201. The molding part 500 may be provided on an outer surface of the punch head 410 in the direction in which the metal sheet 10 seated on the die 300 is located.

In one embodiment, the molding part 500 may have a plurality of patterns 501 disposed to be spaced apart from each other and engraved in the punch head 410. The plurality of patterns 501 may be formed in any one of a circular shape, an elliptical shape, a polygonal shape, a cross shape, a zigzag shape, and a wavy shape.

In another embodiment, the molding part 500 may include a molding body portion 510 and patterns 520.

The molding body portion 510 may be coupled detachably to the punch head 410. The molding body portion 510 may be coupled to the outer surface of the punch head 410 in the direction in which the metal sheet 10 seated on the die 300 is located.

The pattern 520 may be engraved in the molding body portion 510. The pattern 520 may be formed on the outer surface of the molding body portion 510 in the direction in which the metal sheet 10 seated on the die 300 is located. A plurality of patterns 520 may be disposed to be spaced apart from each other on the molding body portion 510. The plurality of patterns 520 may be formed in any one of a circular shape, an elliptical shape, a polygonal shape, a cross shape, a zigzag shape, and a wavy shape.

The stripper 600 may be seated on the metal sheet 10. The stripper 600 may fix the metal sheet 10 to the die 300 by pressing the metal sheet 10 to prevent the metal sheet 10 from moving. The stripper 600 may be provided with through holes 610 through which the punch head 410 passes. The through hole 610 may be formed to pass through the stripper 600 in the thickness direction.

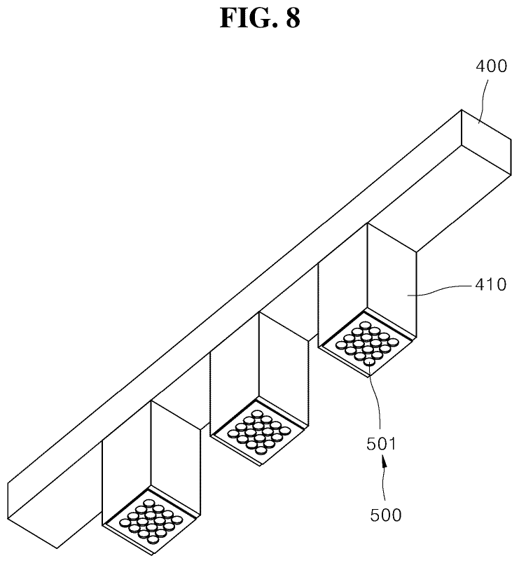

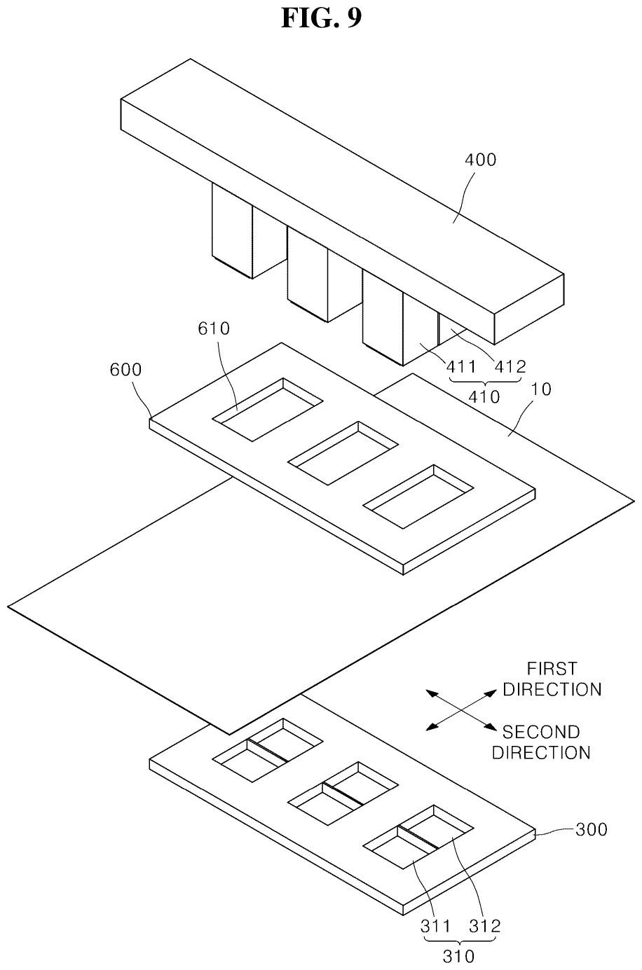

FIG. 9 is an exploded perspective view schematically showing a device for manufacturing the secondary battery according to the second embodiment of the present invention, and FIG. 10 is a bottom perspective view schematically showing a punch in the device for manufacturing the secondary battery according to the second embodiment of the present invention.

Referring to FIGS. 2, 9, 10, and 11 to 14, the device for manufacturing the secondary battery according to the second embodiment of the present invention may include a die 300, a punch 400, a molding part 500, and a stripper 600.

The metal sheet 10 may be seated on the die 300. The metal sheet 10 may be a material for the housing 200 that accommodates the electrode assembly 100 in the secondary battery 1 according to an embodiment of the present invention.

The die 300 may be provided with a recess 310 for molding the accommodating part 201 that is formed in the housing 200 to accommodate the electrode assembly 100. The recess 310 may be formed to be recessed in an outer surface of the die 300 on which the metal sheet 10 is seated. The recess 310 may include a first recess 311 and a second recess 312.

The first recess 311 may be formed to have a shape corresponding to the first accommodating part 201a in which the first portion 100a of the electrode assembly 100 is accommodated. In other words, the first recess 311 may be formed to have a size corresponding to the first accommodating part 201a. The first recess 311 may be formed by recessing the die 300 to a set depth and formed to pass through the die 300 in the thickness direction.

The second recess 312 may be disposed to be spaced apart from the first recess 311. The second recess 312 may be formed to have a shape corresponding to the second accommodating part 201b in which the second portion 100b of the electrode assembly 100 is accommodated. In other words, the second recess 312 may be formed to have a size corresponding to the second accommodating part 201b. The second recess 312 may be formed by recessing the die 300 to a set depth and formed to pass through the die 300 in the thickness direction.

The punch 400 may be spaced apart from and disposed to face the die 300 and disposed to be movable toward the die 300. The die 300 may move back and forth. The punch 400 may be provided with a punch head 410. The punch head 410 may protrude from the punch 400 and extend in the direction in which the die 300 is located.

The punch head 410 may include a first punch head 411 and a second punch head 412. The first punch head 411 may be inserted into the first recess 311 while pressing the metal sheet 10 seated on the die 300 to mold the first accommodating part 201a in the metal sheet 10.

The second punch head 412 may be disposed to be spaced apart from the first punch head 411. The second punch head 412 may be inserted into the second recess 312 while pressing the metal sheet 10 seated on the die 300 to mold the second accommodating part 201b in the metal sheet 10.

The molding part 500 may be provided on each of the first punch head 411 and the second punch head 412. The molding part 500 may mold the insulating part 202, which protrudes toward the first portion 100a and the second portion 100b of the electrode assembly 100, in each of the first accommodating part 201a and the second accommodating part 201b. The molding part 500 may be provided on each of an outer surface of the first punch head 411 and an outer surface of the second punch head 412 in the direction in which the metal sheet 10 seated on the die 300 is located.

The stripper 600 may be seated on the metal sheet 10. The stripper 600 may fix the metal sheet 10 to the die 300 by pressing the metal sheet 10 in order to prevent the metal sheet 10 from moving. The stripper 600 may be provided with through holes 610 through which the first punch head 411 and the second punch head 412 pass. The through hole 610 may be formed to pass through the stripper 600 in the thickness direction.

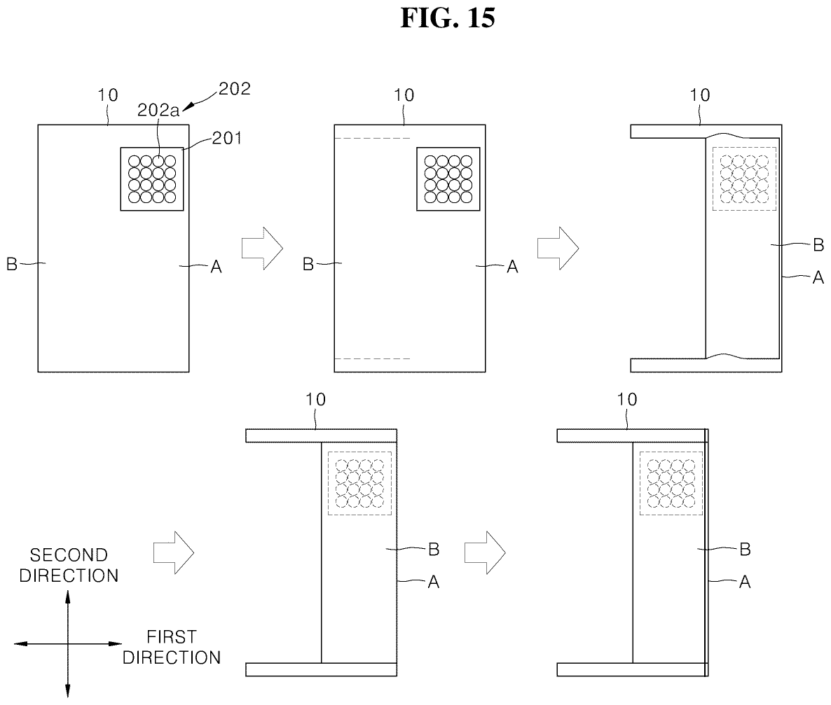

FIG. 15 is a flowchart schematically showing a method of manufacturing the secondary battery according to the first embodiment of the present invention. Referring to FIGS. 1, 3 to 6, 7, and 15, the method of manufacturing the secondary battery according to embodiments of the present invention may include preparing the metal sheet 10.

The metal sheet 10 may be a material for the housing 200 that accommodates the electrode assembly 100 in the secondary battery 1 according to the first embodiment of the present invention. The metal sheet 10 may be seated on the die 300. The metal sheet 10 may be transported in a first direction by a transport device (not shown) in a state of being seated on the die 300.

The insulating part 202 protruding from the accommodating part 201 toward the electrode assembly 100 may be molded while the accommodating part 201 in which the electrode assembly 100 is accommodated is molded in a first portion A of the metal sheet 10. The first portion A of the metal sheet 10 may include the container 210 provided with the accommodating portion 201.

Both sides of a second portion B may be slit in the first direction so that the second portion B of the metal sheet 10 is limited to a set area. The second portion B of the metal sheet 10 may include a cover 220 connected to the first container 210 and coupled to the container 210 to cover an opening provided in one surface of the container 210.

The second portion B may be bent toward the first portion A so that the slit second portion B of the metal sheet 10 overlaps the first portion A of the metal sheet 10.

An area between the first portion A and the second portion B may be folded so that the first portion A of the metal sheet 10 and the second portion B of the metal sheet 10 are folded.

One side of the first portion A and one side of the second portion B of the metal sheet 10 may be cut in the second direction intersecting the first direction so that an area of the first portion A and an area of the second portion B of the metal sheet 10 are identical.

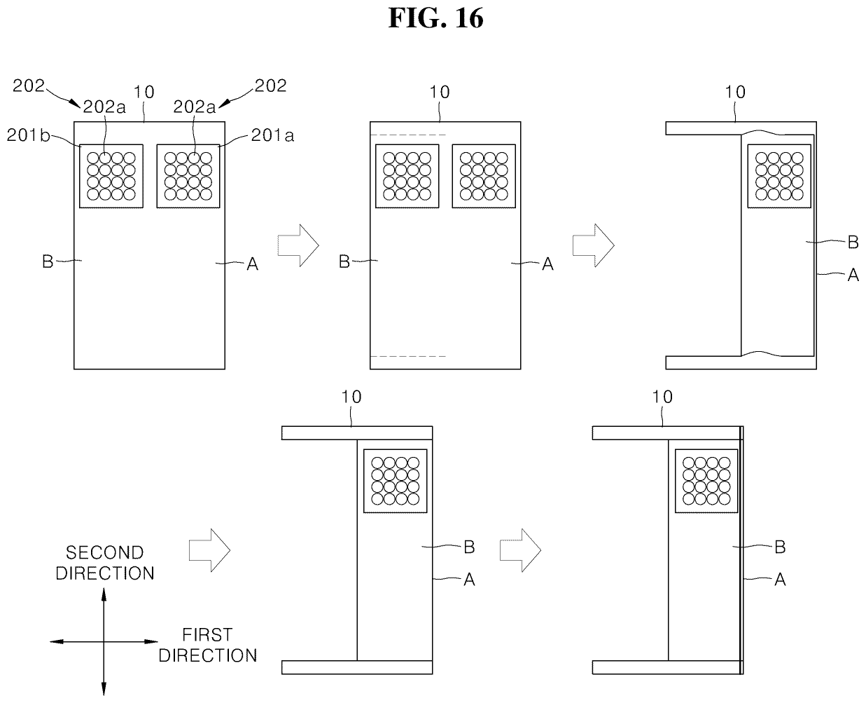

FIG. 16 is a flowchart schematically showing a method of manufacturing the secondary battery according to the second embodiment of the present invention. Referring to FIGS. 2, 3 to 6, 9, and 16, the method of manufacturing the secondary battery according to the second embodiment of the present invention may include preparing the metal sheet 10.

The metal sheet 10 may be a material for the housing 200 that accommodates the electrode assembly 100 in the secondary battery 1 according to the second embodiment of the present invention. The metal sheet 10 may be seated on the die 300. The metal sheet 10 may be transported in the first direction by a transport device (not shown) in a state of being seated on the die 300.

The insulating part 202 protruding from the first accommodating part 201a toward the first portion 100a of the electrode assembly 100 may be molded while the first accommodating part 201a in which the first portion 100a of the electrode assembly 100 is accommodated is molded in the first portion A of the metal sheet 10. The first portion A of the metal sheet 10 may include the first container 230 provided with the first accommodating part 201a.

The insulating part 202 protruding from the second accommodating part 201b toward the second portion 100b of the electrode assembly 100 may be molded while the second accommodating part 201b in which the second portion 100b of the electrode assembly 100 is accommodated is molded in the second portion B of the metal sheet 10. The second portion B of the metal sheet 10 may include the second container 240 provided with the second accommodating part 201b.

Both sides of the second portion B may be slit in the first direction so that the second portion B of the metal sheet 10 is limited to a set area. The second portion B of the metal sheet 10 may include the second container 240 connected to the first container 230 and coupled to the first container 230.

The second portion B may be bent toward the first portion A so that the slit second portion B of the metal sheet 10 overlaps the first portion A of the metal sheet 10.

An area between the first portion A and the second portion B may be folded so that the first portion A of the metal sheet 10 and the second portion B of the metal sheet 10 are folded.

One side of the first portion A and one side of the second portion B of the metal sheet 10 may be cut in the second direction intersecting the first direction so that an area of the first portion A and an area of the second portion B of the metal sheet 10 are identical.

According to embodiments of the present invention, since an insulating layer is formed between a housing and an electrode assembly by an insulating part formed to protrude from an accommodating part in which the electrode assembly is accommodated, the characteristics of the secondary battery are not significantly changed even when an external temperature changes, and it is possible to prevent damage to the secondary battery even when an external force is applied to the housing.

However, the effects obtainable through the present disclosure are not limited to the above effects, and other technical effects that are not mentioned will be clearly understood by those skilled in the art from the following description of the present disclosure.

While the present disclosure has been described with reference to embodiments shown in the drawings, these embodiments are merely illustrative and it should be understood that various modifications and equivalent other embodiments can be derived by those skilled in the art on the basis of the embodiments.

Therefore, the technical scope of the present disclosure should be defined by the appended claims.

What is claimed is:

1. A secondary battery comprising:
an electrode assembly; and
a housing provided with an accommodating part in which the electrode assembly is accommodated and an insulating part protruding from the accommodating part toward the electrode assembly.

2. The secondary battery of claim 1, wherein the housing includes:
a container provided with the accommodating part; and
a cover coupled to the container to cover an opening provided in one surface of the container.

3. The secondary battery of claim 1, wherein the housing includes:
a first container configured to cover a first portion of the electrode assembly; and
a second container coupled to the first container and covering a second portion of the electrode assembly.

4. The secondary battery of claim 3, wherein the accommodating part includes:
a first accommodating part provided in the first container to accommodate the first portion; and
a second accommodating part provided in the second container to accommodate the second portion.

5. The secondary battery of claim 1, wherein the insulating part includes a plurality of protrusions disposed to be spaced apart from each other.

6. The secondary battery of claim 5, wherein the plurality of protrusions are formed in any one of a circular shape, an elliptical shape, a polygonal shape, a cross shape, a zigzag shape, and a wavy shape.

7. A device for manufacturing a secondary battery, comprising:
a die on which a metal sheet is seated and which is provided with a recess having a shape corresponding to an accommodating part in which an electrode assembly is accommodated;
a punch disposed to be movable toward the die and provided with a punch head inserted into the recess while pressing the metal sheet to mold the accommodating part in the metal sheet; and
a molding part provided on the punch head and molding an insulating part protruding toward the electrode assembly in the accommodating part.

8. The device of claim 7, further comprising a stripper seated on the metal sheet to fix the metal sheet to the die.

9. The device of claim 8, wherein a through hole through which the punch head passes is provided in the stripper.

10. The device of claim 7, wherein the recess includes:
a first recess; and
a second recess disposed to be spaced apart from the first recess.

11. The device of claim 10, wherein the punch head includes:
a first punch head inserted into the first recess; and
a second punch head disposed to be spaced apart from the first punch head and inserted into the second recess.

12. The device of claim 7, wherein the molding part includes a plurality of patterns disposed to be spaced apart from each other and engraved in the punch head.

13. The device of claim 7, wherein the molding part includes:
a molding body portion detachably coupled to the punch head; and
a plurality of patterns engraved in the molding body portion and disposed to be spaced apart from each other.

14. The device of claim 13, wherein the plurality of patterns are formed on an outer surface of the molding body portion in a direction in which the metal sheet seated on the die is located.

15. The device of claim 12, wherein the plurality of patterns are formed in any one of a circular shape, an elliptical shape, a polygonal shape, a cross shape, a zigzag shape, and a wavy shape.

16. A method of manufacturing a secondary battery, comprising:
molding an insulating part, which protrudes from a first accommodating part toward an electrode assembly while molding the first accommodating part in which the electrode assembly is accommodated, in a first portion of a metal sheet;
slitting both sides of a second portion in a first direction so that the second portion of the metal sheet is limited to a set area;
bending the second portion toward the first portion so that the second portion overlaps the first portion;
folding an area between the first portion and the second portion; and
cutting one side of the first portion and one side of the second portion in a second direction intersecting the first direction.

17. The method of claim 16, further comprising molding the insulating part, which protrudes from a second accommodating part toward the electrode assembly while molding the second accommodating part in which the electrode assembly is accommodated, in the second portion.
